(19) United States
(12) Patent Application Publication
(10) Pub. No.: US 2016/0167250 A1
(43) Pub. Date: Jun. 16, 2016

(54) EXTRUSION-COATED ARTICLES WITH END-CAPS

(71) Applicant: EASTMAN CHEMICAL COMPANY, Kingsport, TN (US)

(72) Inventors: Kevin Michael Cable, Kingsport, TN (US); Daniel Christopher Cobb, Kingsport, TN (US); Michael W. Cradic, Kingsport, TN (US); Michael L. Herrig, Johnson City, TN (US)

(73) Assignee: EASTMAN CHEMICAL COMPANY, Kingsport, TN (US)

(21) Appl. No.: 14/571,568

(22) Filed: Dec. 16, 2014

(51) Int. Cl. B27N 7/00

(52) U.S. Cl. CPC B27N 7/005

(57) ABSTRACT

The present invention is directed to an extrusion-coated article comprising: a substrate with a coating material extrusion coated onto at least a portion of the substrate, and at least one profile extruded end-cap coupled with an end of the substrate, with a cross-section of the end-cap comprising an end-cap profile. The end of the substrate includes a recess extending inwardly from an outer surface of the end of the substrate, such that a cross-section of the end of the substrate comprises a substrate end profile. The end-cap profile substantially corresponds with the substrate end profile, such that at least a portion of the end-cap is configured to be received within the recess for coupling the end-cap with the end of the substrate.

### FIELD OF THE INVENTION

This invention relates to extrusion-coated articles. In particular, the present invention relates to extrusion-coated articles with end-caps, which are useful for furniture and other applications, as well as methods of making and using the same.

### BACKGROUND

Many typical substrates (e.g., plywood, particle board, medium density fiberboard (MDF), or the like) used in the production of ready to assemble (RTA) furniture and shelving structures lack strength and durability and, oftentimes, have a limited usable life. One potential process for enhancing the strength, durability, and/or aesthetics of an RTA structure is to apply a coating material to each of the surfaces of the substrates of which the structure is comprised. For example, in some processes, melamine and paper foils may be used to cover the exposed faces of the substrates. Additionally, an edge banding material, such as PVC, ABS, melamine, paper foil, wood, or wood veneer may be used on the exposed edges of the substrates. However, such processes are problematic in that it is difficult to obtain a satisfactory sealing relationship between the material comprising the face coverings and the material comprising the edge banding. In particular, gaps may be present between such materials, thus, allowing water to penetrate and contact the substrate. The water may cause the substrate to swell, or may otherwise cause the underlying substrate to fail and/or to exhibit an undesirable final appearance.

In certain other processes, such as the processes described in U.S. Pat. Nos. 6,660,086 and 7,374,795, which are each herein incorporated by reference in their entireties, each of the faces and two of the edges of the substrate may be extrusion-coated in a continuous thermoplastic coating, so as to provide for a seamless transition between the two faces and the two edges. However, the two remaining edges may not be extrusion coated in the process, thus, leaving at least a portion of the substrate exposed and unprotected. Edge banding the two remaining edges may not alleviate such problems, as gaps may remain present between the coated faces and the two remaining banded edges.

Thus, a need exists for an improved process and articles made therefrom with the capability of forming a seamless coating on all six sides of the article's substrate (i.e., the two faces and the four edges). Preferably, such a coated substrate would also be capable of being produced both conveniently and inexpensively, while still providing final products having a high level of quality.

### SUMMARY

One embodiment of the present invention includes an extrusion-coated article comprising a substrate, a coating material extrusion coated onto at least a portion of the substrate, and at least one profile extruded end-cap coupled with an end of the substrate. A cross-section of the end-cap has an end-cap profile. The end of the substrate includes a recess extending inwardly from an outer surface of the end of the substrate, such that a cross-section of the end of the substrate comprises a substrate end profile. The end-cap profile substantially corresponds with the substrate end profile, such that at least a portion of the end-cap is configured to be received within the recess for coupling the end-cap with the end of the substrate.

Another embodiment of the present invention includes a method for forming an extrusion-coated article. The method comprises the steps of: (a) providing a substrate, (b) forming a recess through an end of the substrate, (c) profile extruding an end-cap, and (d) coupling the end-cap with the end of the substrate, and (e) extrusion-coating the substrate and the end-cap so as to coat at least a portion of both the substrate and the end-cap with a coating material. The end-cap includes a cross-section comprising an end-cap profile. The end of the substrate comprises a recess extending inwardly from an outer surface of the end of the substrate, such that a cross-section of the end comprises a substrate end profile. The end-cap profile substantially corresponds with the substrate end profile, such that at least a portion of the end-cap is configured to be received within the recess for coupling the end-cap with the end of the substrate.

Yet another embodiment of the present invention includes a method for forming an extrusion-coated article. The method comprises the steps of: (a) providing a substrate and an end-cap, (b) coupling the end-cap with an end of the substrate, (c) passing the coupled substrate and end-cap through an extrusion-coater so as to coat at least a portion of each of the substrate and the end-cap with a coating material, and (d) machining an end portion of the end-caps, such that the end-caps present a smooth outer surface. During the passing of step (c), the coating material at least partially fuses with the end-cap, so as to form a seal around the end of the substrate.

### BRIEF DESCRIPTION OF THE DRAWINGS

Various embodiments of the present invention are described in detail below with reference to the attached drawing figures, wherein:

FIG. 1 is a perspective partial view of one embodiment of an extrusion-coated article, with a portion of the article cut away showing a substrate and an end-cap coupled therewith;

FIG. 2 is a perspective partial schematic view of one embodiment of a substrate and an end-cap, with the end-cap, in phantom view, shown being attached to the substrate;

FIG. 3 is a flow chart of a process for forming an extrusion-coated article according to embodiments of the present invention;

FIG. 4 is a perspective partial view of one embodiment of a substrate, with the substrate having recesses formed on its end edges;

FIG. 5 is a first perspective view of one embodiment of an end-cap;

FIG. 6 is a second perspective view of the end-cap from FIG. 5;

FIG. 7 is a perspective partial schematic view of another embodiment of a substrate and an end-cap, with the end-cap, in phantom view, shown being attached to the substrate;

FIG. 8 is a perspective partial schematic view of still another embodiment of a substrate and an end-cap, with the end-cap, in phantom view, shown being attached to the substrate;

FIG. 9 is a perspective partial view of one embodiment of an extrusion-coated article, with the article having a substrate and an end-cap coupled with each of the substrate's end edges, and with a coating material coated on the substrate and seamlessly fused with the end-caps;

FIG. 10 is a perspective partial view of one embodiment of an extrusion-coated article, with a portion of the article cut away showing a substrate and an end-cap coupled therewith, and with the end-cap having an oversized base portion, such that a portion of the base portion can be trimmed away;

FIG. 11 is a perspective partial view of two substrates being separated by a spacing element;

FIG. 12 is a perspective view of a double-sided end-cap according to embodiments of the present invention; and

FIG. 13 is a perspective partial view of two substrates being interconnected by the double-sided end-cap of FIG. 12, with the two substrates and the double-sided end-cap being coated with a coating material, and with a portion of the substrates and the double-sided end-cap being cut away.

### DETAILED DESCRIPTION

In one aspect, the present invention relates to extrusion-coated articles, as well as methods for making and using the same. As used herein, the term “extrusion-coated article” refers to a substrate which has been coated, or at least partially coated, with a coating material via an extrusion-coating process in which the coating material is applied directly to the substrate and the coating material is applied in a molten, melted or fluid form. The extrusion coating process excludes forming a film from the coating material and applying the pre-formed film to the substrate. Extrusion-coated articles configured according to embodiments of the present invention may be more durable, easier to assemble, and may provide enhanced aesthetic appearance over similar, conventionally-made articles. Additionally, embodiments of the present invention provide for the underlying substrates to be completely sealed from water, reducing the likelihood of the articles swelling and/or otherwise structurally failing. Articles according to the present invention may be used in a variety of interior and exterior applications including, for example, as components of furniture or cabinetry, or as building materials such as flooring, wall covering, trim, molding, and the like. Because embodiments of the present invention provide for the substrates to be completely sealed from external contaminants (e.g., water), the articles may be especially fit for use in locations where long-term water exposure is expected, such as bathroom shelves and cabinets and wet mop-ready flooring boards.

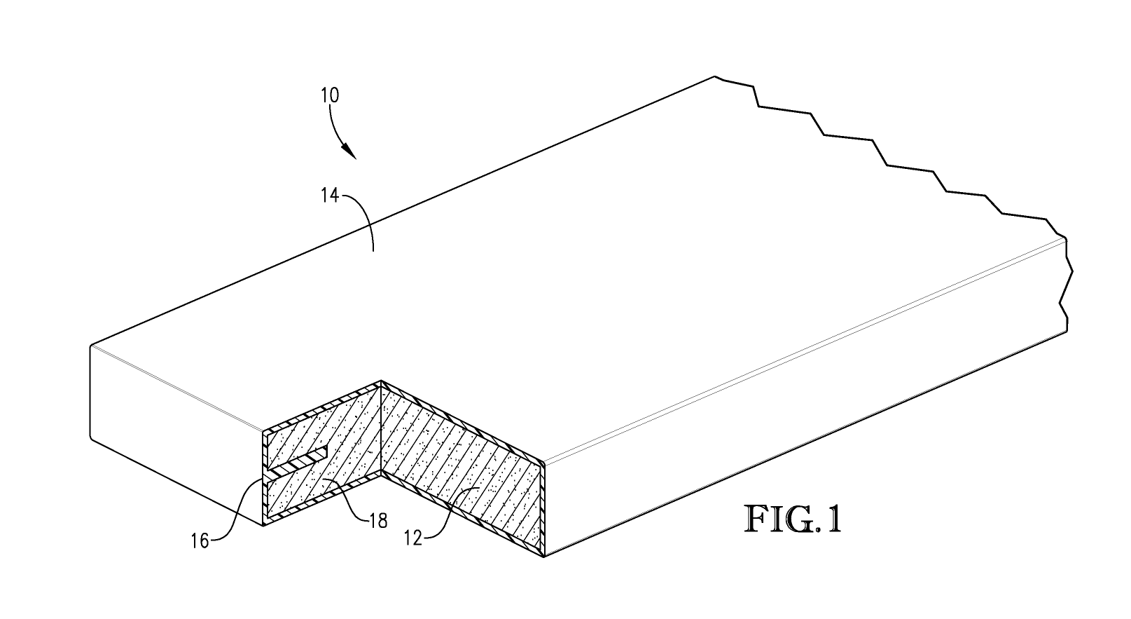

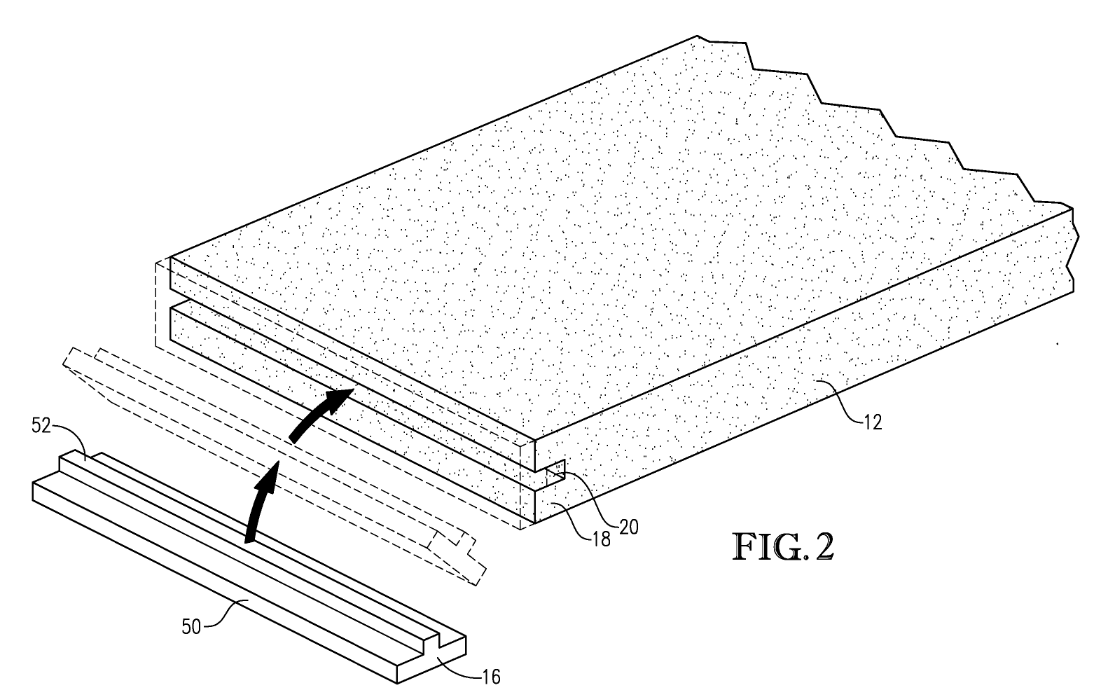

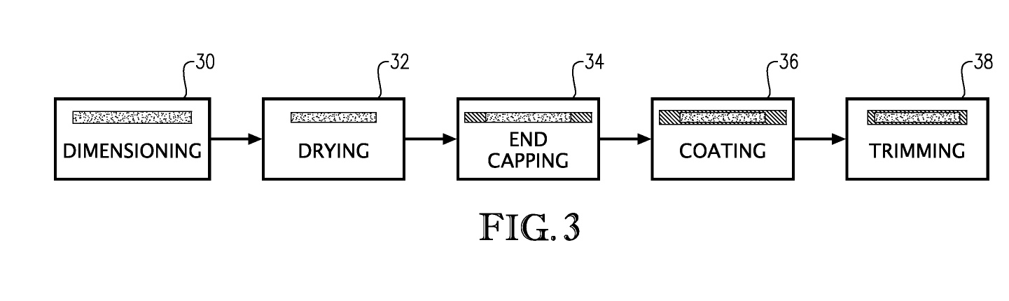

Turning to the drawings, embodiments of the present invention are directed to an extrusion-coated article 10, such as illustrated in FIG. 1, comprising: (1) a substrate 12 with a coating material 14 extrusion-coated onto at least a portion of the substrate 12, and (2) at least one end-cap 16 coupled with an end 18 of the substrate 12, with a cross-section of the end-cap presenting an end-cap profile. With reference to FIG. 2, in some embodiments, the end 18 of the substrate 12 will comprises a recess 20 extending inwardly from an outer surface of the end 18 of the substrate 12, such that a cross-section of the end 18 of the substrate 12 presents a substrate end profile. As such, in some embodiments, the end-cap profile will correspond with the substrate end profile, such that at least a portion of the end-cap 16 is operable to be received within the recess 20 of the substrate 12 so as to couple the end-cap 16 with the substrate 12. Given the article 10 described above, embodiments of the present invention provide for such an article 10 to be formed in a manner in which all of the sides of the underlying substrate 12 are seamlessly covered by the coating material 14 and/or the end-caps 16, such that the substrate 12 is entirely sealed from external contamination, e.g., water or other liquids. As illustrated in FIG. 3, the extrusion-coated articles 10 can be formed in an extrusion process that includes the following stages, each of which will be described in more detail below: a dimensioning stage 30, a drying stage 32, an end-capping stage 34, a coating stage 36, and a trimming stage 38. The substrate 12 and/or coated article 10 may be transferred from stage-to-stage in an assembly line fashion, such as via a conveyor, rollers, or the like.

The substrate 12 of the article 10 can comprise one material or a plurality of materials. For example, in one embodiment, the substrate 12 can comprise a non-natural wood material. As used herein, the term “non-natural wood material” refers to any material that includes at least one component other than natural wood. Examples of components other than natural wood can include, but are not limited to, binders, adhesives, plastics, and other materials. Some non-natural wood substrates 12 may include a wood composite (or engineered wood) material that comprises smaller bodies of wood bound together by adhesive, plastic, or other binder material. Specific examples of wood composite materials include, but are not limited to, medium density fiber board (MDF), high density fiberboard (HDF), particle board, oriented strand board (OSB), wood-filled plastic, wood-plastic composites, ultralight density fiber board (LFB), plywood, and combinations thereof. Other types of non-natural wood materials may, for example, be selected from the group consisting of plastics, glass, metals, foams, fiberglass-reinforced thermoset or thermoplastic polymers, cellularized PVC, and combinations thereof. In other embodiments, the substrates 12 may comprise a material selected from the group consisting only of wood or wood composites.

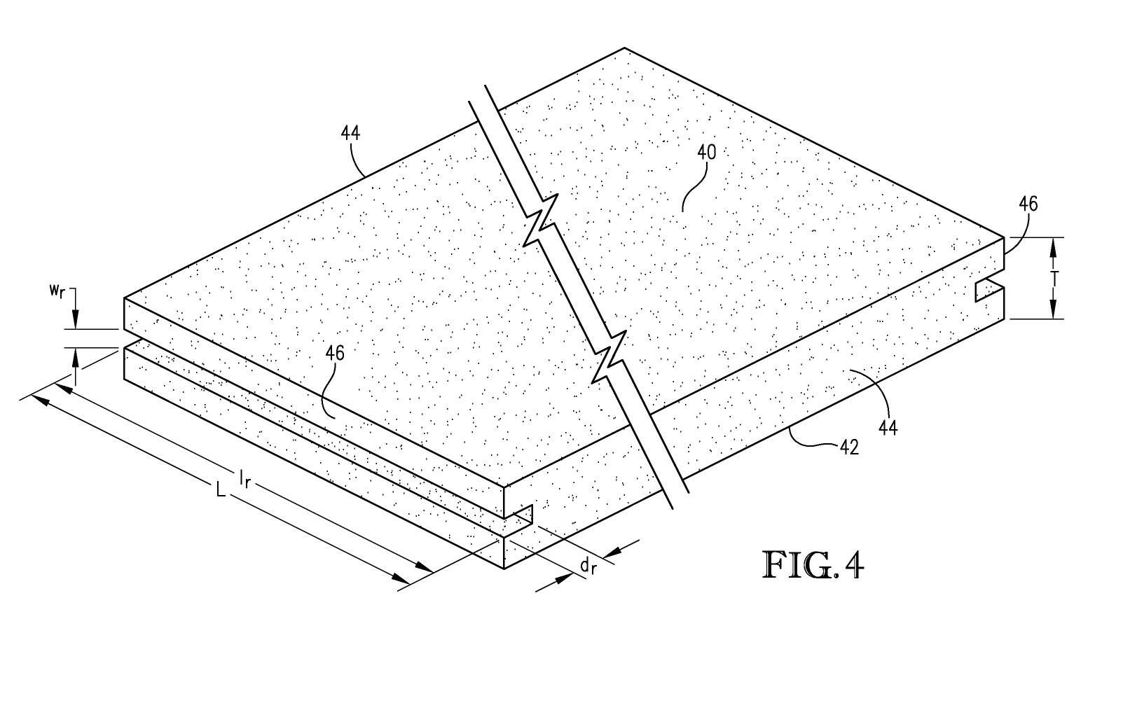

The substrates 12 of embodiments of the present invention can be provided in various sizes and shapes, such as may be required for the production of final products created with the articles 10, e.g., furniture, cabinetry, flooring, wall covering, trim, molding, and the like. Nevertheless, the exemplary substrate 12 described herein, as illustrated in the figures and specifically in FIG. 4, is generally rectangular (such as may be used as a table or cabinet top), having a top face 40 and a bottom face 42, with such faces separated by two elongated side edges 44 and two end edges 46. As will be described in more detail below and as illustrated in FIG. 2, the substrate 12 may comprise at least one recess 20 on each of its ends 18, such that certain portions of the ends 18 will present a cross-section profile (i.e., the substrate end profile) that includes the recesses 20.

In some embodiments, the coating material 14 may comprise at least one thermosetting and/or thermoplastic resin, optionally in combination with additional components. For example, the coating material 14 may comprise a thermoplastic resin selected from linear thermoplastic resins, branched thermoplastic resins, hyperbranched thermoplastic resins, and star-shaped thermoplastic resins. Non-limiting examples of suitable thermoplastic resins include polyesters, copolyesters, acrylics, polycarbonates, and mixtures thereof. Additional non-limiting examples include poly(ethylene terephthalate) (PET), glycol modified PET (PETG) copolyester, poly(methyl methacrylate) (PMMA), poly(acrylonitrile-styrene-acrylate) (ASA), poly(acrylonitrile-butadiene-styrene) (ABS), poly(styrene-acrylonitrile) (SAN) and mixtures thereof. Examples of thermoplastic resins include, but are not limited to, EASTAR copolyester 6763, a PETG available from Eastman Chemical Company; LURAN HD, a SAN available from BASF; TERLURAN GP-22, an ABS available from BASF; Modified Acrylate, a PMMA available from Degussa; and CENTREX 833, an ASA available from Lanxess.

In one aspect the thermoplastic or thermosetting resin coating material 14 comprises a copolyester comprising at least 80 mole % acid residues from terephthalic acid, derivatives of terephthalic acid and mixtures thereof, at least 80 mole % glycol residues from ethylene glycol and 1,4-cyclohexanedimethanol, wherein the acid residues are based on 100 mole % acid residues and the glycol residues are based on 100 mole % glycol residues.

In one aspect the thermoplastic or thermosetting resin coating material 14 comprises a polyester comprising 70 to 100 mole % acid residues from terephthalic acid, 0 to 30 mole % aromatic dicarboxylic acid residues having up to 20 carbon atoms, and 0 to 10 mole % of aliphatic dicarboxylic acid residues having up to 16 carbon atoms wherein the acid residues are based on 100 mole % acid residue. In one aspect the thermoplastic or thermosetting resin coating material 14 comprises a polyester comprising 80 to 100 mole % acid residues from terephthalic acid, 0 to 20 mole % aromatic dicarboxylic acid residues having up to 20 carbon atoms, and 0 to 10 mole of aliphatic dicarboxylic acid residues having up to 16 carbon atoms wherein the acid residues are based on 100 mole % acid residues. In one aspect the thermoplastic or thermosetting resin coating material 14 comprises a polyester comprising 90 to 100 mole % acid residues from terephthalic acid, 0 to 10 mole % aromatic dicarboxylic acid residues having up to 20 carbon atoms, and 0 to 10 mole % of aliphatic dicarboxylic acid residues having up to 16 carbon atoms wherein the acid residues are based on 100 mole % acid residues.

In another aspect the present invention provides coating material 14 comprising a polyester comprising: (a) at least 80 mole % acid residues from terephthalic acid, derivatives of terephthalic acid and mixtures thereof, (b) at least 80 mole % glycol residues from ethylene glycol and 1,4-cyclohexanedimethanol, wherein the acid residues are based on 100 mole acid residues and the glycol residues are based on 100 mole % glycol residues.

In another aspect the present invention provides coating material 14 comprising a polyester comprising: (i) an acid component comprising: (a) at least 70 mole % acid residues from terephthalic acid, derivatives of terephthalic acid and mixtures thereof; (b) from 0 to 30 mole acid residues from aromatic dicarboxylic acids; and (c) from 0 to 10 mole acid residues from aliphatic dicarboxylic acids having up to 20 carbon atoms; and (ii) a glycol component comprising: (a) from 20 to 70 mole % glycol residues from cyclohexanedimethanol; (b) from 0 to 80 mole % glycol residues from ethylene glycol; and (c) from 0 to 80 mole % glycol residues from glycols having up to 20 carbon atoms, wherein the acid residues are based on 100 mole % acid residues and the glycol residues are based on 100 mole % glycol residues.

In another aspect the present invention provides an article comprising a polyester comprising: (i) an acid component comprising: (a) at least 70 mole % acid residues from terephthalic acid, derivatives of terephthalic acid and mixtures thereof; (b) from 0 to 30 mole % acid residues from aromatic dicarboxylic acids; and (c) from 0 to 10 mole % acid residues from aliphatic dicarboxylic acids having up to 20 carbon atoms; (ii) a glycol component comprising: (a) from 20 to 81 mole % glycol residues from cyclohexanedimethanol; (b) from 0 to 80 mole % glycol residues from ethylene glycol; and (c) from 0 to 80 mole % glycol residues from glycols having up to 20 carbon atoms, wherein the acid residues are based on 100 mole % acid residues and the glycol residues are based on 100 mole % glycol residues.

The coating material 14 can also comprise additional components typically included in coating formulations, such as, for example, color pigment, UV stabilizers, compatibilizers, rubbers, gloss modifiers (e.g., calcium carbonate), opacity modifiers (e.g., titanium dioxide), impact modifiers (e.g., styrene-butadiene-styrene polymers, acrylonitrile-butadiene-styrene polymers, or methacrylate-butadiene-styrene polymers), and other types of stabilizers typically employed to ensure a durable and appealing finish to the coating applied to the substrate. In one or more embodiments, gloss modifiers can constitute in the range of from about 10 to about 40 weight percent of the coating material 14, based on the entire weight of the coating material 14. Additionally, in various embodiments, opacity modifiers can constitute in the range of from about 1 to about 10 weight percent of the coating material 14, based on the entire weight of the coating material 14. Furthermore, in various embodiments, impact modifiers can constitute in the range of from 0 to about 20 weight percent of the coating material 14, based on the entire weight of the coating material 14. Other optional elements, such as UV stabilizers or emulsifiers, can be present in individual amounts ranging from 0 to about 20 weight percent of the coating material 14, based on the entire weight of the coating material 14.

Suitable coating materials 14 can include thermoplastic resins having one or more properties within certain ranges. For example, in one embodiment, the thermoplastic resin employed in the coating material 14 that is extrusion coated onto the substrate 12 may have a glass transition temperature of at least about 60° C., at least about 70° C., at least about 80° C. and/or not more than about 150° C., not more than about 140° C., or not more than about 130° C. The glass transition temperature can be in the range of from about 60 to about 150° C., about 60 to about 140° C., about 60 to about 130° C., about 70 to about 150° C., about 70 to about 140° C., about 70 to about 130° C., about 80 to about 150° C., about 80 to about 140° C., and about 80 to about 130° C.

Nevertheless, such coating material 14 can be any coating material exhibiting sufficient processability and adhesion to the selected substrate 12. In one embodiment, the coating material 14 may have an elongation at break, as measured by ASTM D882, of at least about 1 percent, at least about 5 percent, at least about 10 percent, at least about 25 percent, at least about 40 percent, at least about 55 percent, at least about 70 percent and/or not more than about 250 percent, not more than about 200 percent, not more than about 150 percent, or not more than about 100 percent. The elongation at break of the coating material 14 used in one or more embodiments described herein may be in the range of from about 1 to about 250 percent, about 1 to about 200 percent, about 1 to about 150 percent, about 1 to about 100 percent, about 5 to about 250 percent, about 5 to about 200 percent, about 5 to about 150 percent, about 5 to about 100 percent, about 10 to about 250 percent, about 10 to about 200 percent, about 10 to about 150 percent, about 10 to about 100 percent, about 25 to about 250 percent, about 25 to about 200 percent, about 25 to about 150 percent, about 25 to about 100 percent, about 40 to about 250 percent, about 40 to about 200 percent, about 40 to about 150 percent, about 40 to about 100 percent, about 55 to about 250 percent, about 55 to about 200 percent, about 55 to about 150 percent, about 55 to about 100 percent, about 70 to about 250 percent, about 70 to about 200 percent, about 70 to about 150 percent, about 70 to about 100 percent.

The coating material 14 can have a yield stress of at least about 5 MPa, at least about 10 MPa, at least about 15 MPa, at least about 20 MPa, at least about 25 MPa and/or not more than about 50 MPa, not more than about 45 MPa, not more than about 40 MPa, or not more than about 35 MPa, measured according to the procedure provided in ASTM D882. The yield stress of the coating material 14 used in one or more embodiments described herein can be in the range of from about 5 to about 50 MPa, about 5 to about 45 MPa, about 5 to about 40 MPa, about 5 to about 35 MPa, about 10 to about 50 MPa, about 10 to about 45 MPa, about 10 to about 40 MPa, about 10 to about 35 MPa, about 15 to about 50 MPa, about 15 to about 45 MPa, about 15 to about 40 MPa, about 15 to about 35 MPa, about 20 to about 50 MPa, about 20 to about 45 MPa, about 20 to about 40 MPa, about 20 to about 35 MPa, about 25 to about 50 MPa, about 25 to about 45 MPa, about 25 to about 40 MPa, about 25 to about 35 MPa. This may be in contrast, for example, to conventional coatings like paints, which have a yield stress of less than 1 MPa.

The coating material 14 can also have a percent yield strain of at least about 1 percent, at least about 2 percent, at least about 5 percent and/or not more than about 8 percent, not more than about 6 percent, as calculated by ASTM D882. This may be, in some cases, lower than conventional coatings, such a paint, which may exhibit a percent yield strain greater than 9 percent. The coating material 14 used herein may also have a modulus of at least about 10 MPa, at least about 50 MPa, at least about 100 MPa, at least about 500 MPa, at least about 1000 MPa, at least about 1200 MPa and/or not more than about 2500 MPa, not more than about 2000 MPa, not more than about 1500 MPa, measured according to ASTM D882. The modulus of the coating material 14 can be in the range of from about 10 to about 2500 MPa, about 10 to about 2000 MPa, about 10 to about 1500 MPa, about 50 to about 2500 MPa, about 50 to about 2000 MPa, about 50 to about 1500 MPa, about 100 to about 2500 MPa, about 100 to about 2000 MPa, about 100 to about 1500 MPa, about 500 to about 2500 MPa, about 500 to about 2000 MPa, about 500 to about 1500 MPa, about 1000 to about 2500 MPa, about 1000 to about 2000 MPa, about 1000 to about 1500 MPa, about 1200 to about 2500 MPa, about 1200 to about 2000 MPa, about 1200 to about 1500 MPa.

The end-caps 16 may be formed from materials that are similar, or the same, as the coating material 14 described above. As non-limiting examples, the end-caps may be formed from polyesters, copolyesters, polycarbonates, poly(ethylene terephthalate) (PET), PETG copolyester, polymethyl methacrylate (PMMA), impact-modified PMMA, poly(acrylonitrile-styrene-acrylate) (ASA), poly(acrylonitrile-butadiene-styrene) (ABS), poly(styrene-acrylonitrile) (SAN), cellulose esters and mixtures thereof. It should be understood, however, that the end-cap material and the coating material should be selected such that the materials will fuse together during the coating stage 36 of the extrusion-coating process. As such, it may be preferable for the end-cap material and the coating material 14 to be the same. For instance, an end-cap 16 formed from PETG will fuse with a PETG coating material 14 applied to the end-cap 16 at the elevated temperature (e.g., 200-300 degrees Celsius). As an alternative, non-preferred example, an end-cap 16 formed from PVC may not properly fuse with a melamine coating material 14. Regardless, certain combination of non-similar materials may facilitate sufficient fusing between the end-caps 16 and the coating material 14.

The end-caps 16 may be formed from various processes, such as machining, injection molding, profile extruding, 3-dimensional printing, or the like, and combinations thereof. Such end-cap forming processes should preferably be capable of forming end-caps 16 that include cross-section profiles that match the cross-section profiles of the ends 18 of the substrates 12 to which they are to be attached.

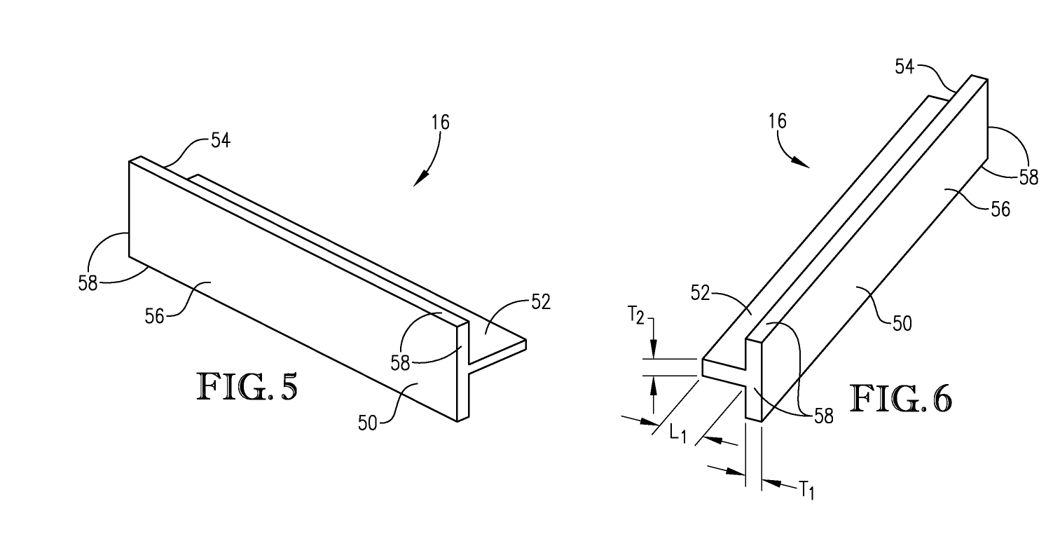

With reference to FIGS. 5 and 6, the end-caps 16 of the articles 10 may comprise a base portion 50 and one or more projections 52 extending from the base portion 50. In some embodiments, however, the end-caps 16 will only include a base portion 50 and will not include one or more projections 52. Nevertheless, the base portion 50 should have a size and shape that substantially matches a size and shape of an end 18 of the substrate 12, such that the base portion 50 of the end-cap 16 will match and align with the end 18 of the substrate 12 when secured to the substrate's 12 end edge 46. As such, in embodiments in which the substrate 12 has a generally rectangular end edge 46, the base portion 50 may comprise a rectangular piece of material with six sides, as illustrated in FIGS. 5-6, including a substrate-facing side 54, a non-substrate-facing side 56, and four side edges 58, with the four side edges 58 separating the substrate-facing and non-facing sides 54, 56. To facilitate the matching of the end-cap 16 with the end 18 of the substrate 12, the substrate-facing side 54 of the end-cap 16 should have generally corresponding size and shape as the end edge 46 of the substrate 12.

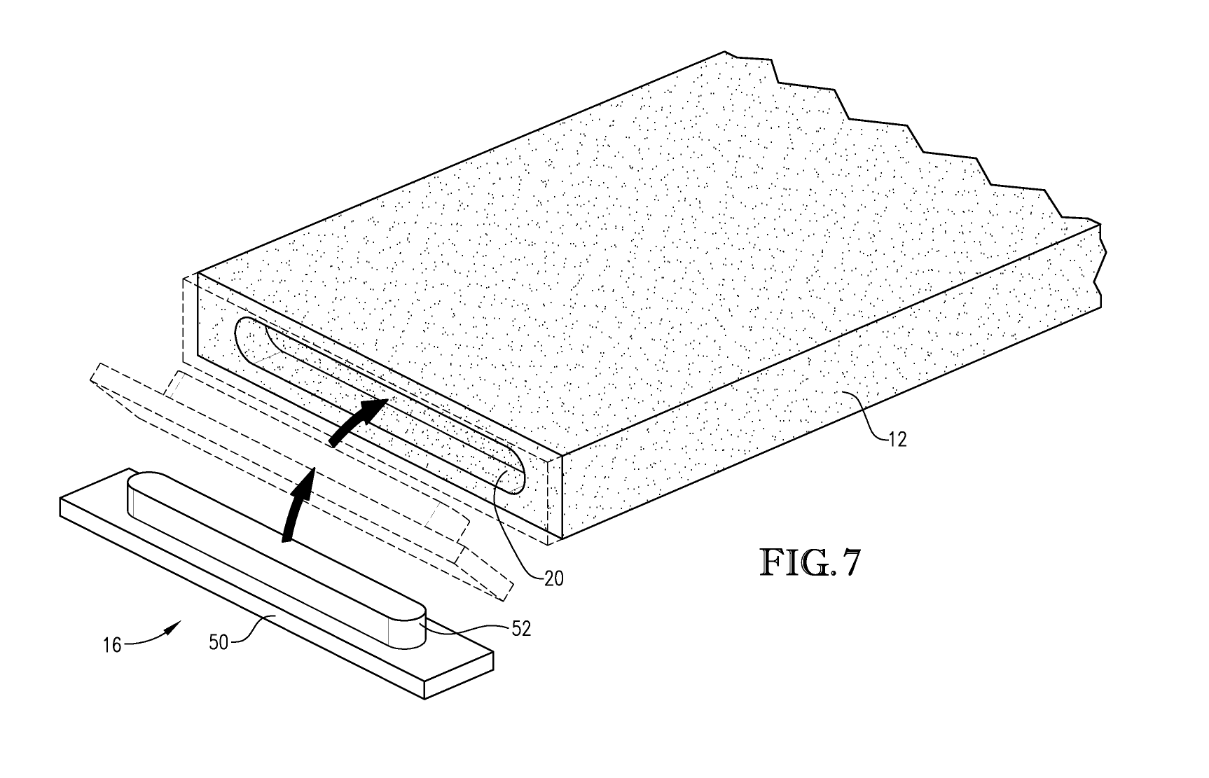

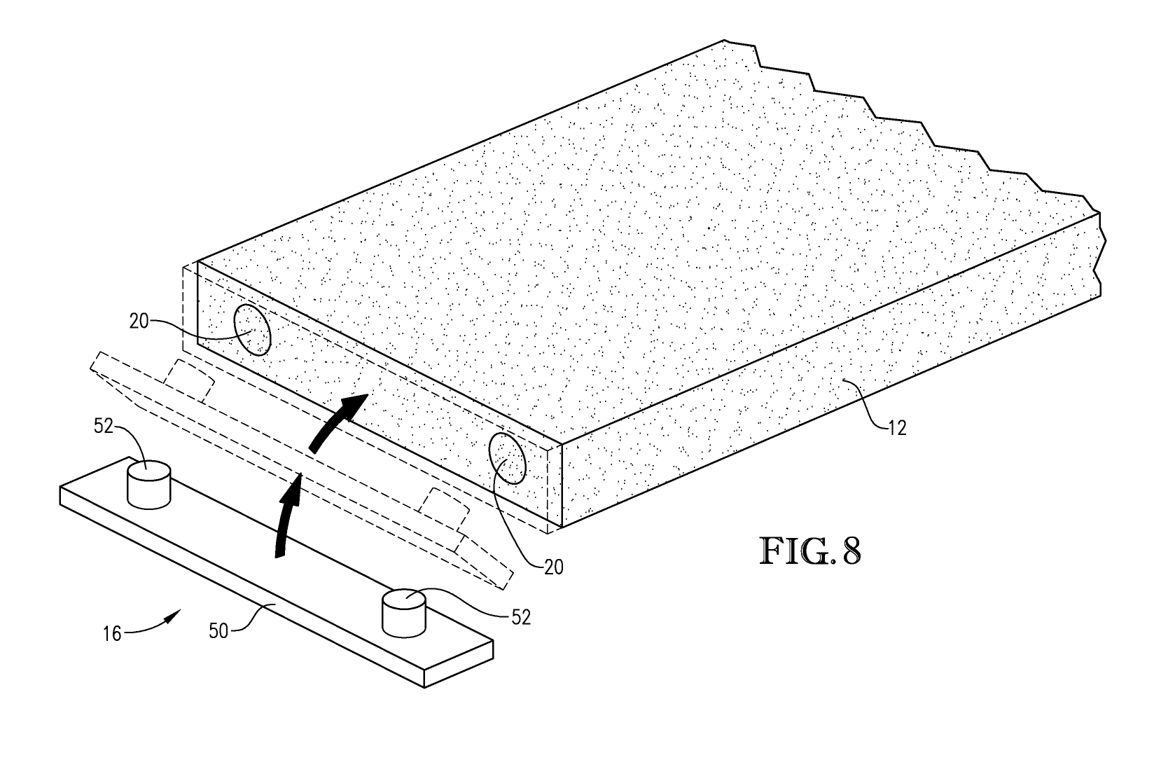

Additionally, the end-cap 16 may include the one or more projections 52 that extend from the base portion 50. In some embodiments, the projection 52 will extend from the substrate-facing side 54 of the base portion 50. In certain embodiments, such as illustrated in FIGS. 2, 5, and 6, the projection 52 may be in the form of a tongue that extends generally orthogonally from the base portion 50, generally along an entire length of the base portion 50. In other embodiments, such as illustrated in FIG. 7, the end-cap 16 may include a projection 52 in the form of a tongue or a tenon that extends generally orthogonally from the base portion 50, along a portion of the length of the base portion 50. In other embodiments, such as illustrated in FIG. 8, the end-cap 16 may include projections 52 in the form of one or more bosses that extend from the base portion 50 at various locations along the length of the base portion 50. Nevertheless, embodiments of the present invention provide for the projections 52 to be formed in various other types and/or various shapes, as may be required or preferred for particular implementations.

Returning to FIGS. 5 and 6, embodiments may provide for a ratio of a maximum thickness of the base portion 50, shown as dimension (T₁), to a maximum thickness of the protrusion 52, shown as dimension (T₂), can be at least about 1:500, at least about 1:400, at least about 1:300, at least 1:250 and/or not more than about 80:1, not more than about 60:1, not more than about 40:1, or not more than about 20:1. The ratio (T₁:T₂) of the maximum thickness of the base portion 50 to the maximum thickness of protrusion 52 can be in the range of from about 1:500 to about 80:1, about 1:500 to about 60:1, about 1:500 to about 40:1, about 1:500 to about 20:1, about 1:400 to about 80:1, about 1:400 to about 60:1, about 1:400 to about 40:1, about 1:400 to about 20:1, about 1:300 to about 80:1, about 1:300 to about 60:1, about 1:300 to about 40:1, about 1:300 to about 20:1, about 1:250 to about 80:1, about 1:250 to about 60:1, about 1:250 to about 40:1, about 1:250 to about 20:1. Although the above ranges may be included in embodiments of the present invention, certain specific embodiments may provide for the ratio (T₁:T₂) of the maximum thickness of the base portion 50 to the maximum thickness of protrusion 52 to be in the range of from about 1:2 to about 8:1, from about 1:1 to about 6:1, from about 2:1 to about 3:1.

The maximum thickness (T₁) of the base portion 50 can be at least about 0.127 mm, at least about 2.54 mm, at least about 12.7 mm, at least about 25.4 mm and/or not more than about 203.2 mm, not more than about 152.4 mm, not more than about 101.6 mm, not more than about 50.8 mm and/or the maximum thickness (T₂) of the protrusion 52 can be at least about 2.54 mm, at least about 12.7 mm, at least about 19.05 mm, at least about 25.4 mm, and/or not more than about 63.5 mm, not more than about 50.8 mm, not more than about 38.1 mm, not more than 31.75 mm. The base portion 50 can have a maximum thickness (T₁) in the range of from about 0.127 to about 203.2 mm, about 0.127 to about 152.4 mm, about 0.127 to about 101.6 mm, about 0.127 to about 50.8 mm, about 2.54 to about 203.2 mm, about 2.54 to about 152.4 mm, about 2.54 to about 101.6 mm, about 2.54 to about 50.8 mm, about 12.7 mm to about 203.2 mm, about 12.7 mm to about 152.4 mm, about 12.7 to about 101.6 mm, about 12.7 to about 50.8 mm, about 25.4 to about 203.2, about 25.4 to about 152.4 mm, about 25.4 to about 101.6 mm, about 25.4 to about 50.8 mm and/or the protrusion 52 can have a maximum thickness (T₂) in the range of from about 2.54 to about 63.5 mm, about 2.54 to about 50.8 mm, about 2.54 to about 38.1 mm, about 12.7 to about 63.5 mm, about 12.7 to about 50.8 mm, about 12.7 to about 38.1 mm, about 19.05 to about 63.5 mm, about 19.05 to about 50.8 mm, about 19.05 to about 38.1 mm.

In one embodiment, protrusion 52 can extend outwardly from the base portion 50 for a maximum distance, shown as (L₁) in FIGS. 5 and 6, for a distance of at least about 2.54 mm, at least about 6.35 mm, at least about 12.7 mm, at least about 25.4 mm, at least about 38.1 mm and/or not more than about 127 mm, not more than about 76.2 mm, not more than about 63.5 mm, not more than about 50.8, or in the range of from about 2.54 to about 127 mm, about 2.54 mm to about 76.2 mm, about 2.54 to about 63.5 mm, about 2.54 to about 50.8 mm, about 6.35 to about 127 mm, about 6.35 to about 76.2 mm, about 6.35 to about 63.5 mm, about 6.35 mm to about 50.8 mm, about 12.7 to about 127 mm, about 12.7 to about 76.2 mm, about 12.7 to about 63.5 mm, about 12.7 to about 50.8 mm, about 25.4 to about 127 mm, about 25.4 to about 76.2 mm, about 25.4 to about 63.5 mm, about 25.4 to about 50.8 mm, about 38.1 to about 127 mm, about 38.1 to about 76.2 mm, about 38.1 to about 63.5 mm, about 38.1 to about 50.8 mm.

The ratio (L₁:T₂) of the maximum distance that protrusion 52 extends outwardly from the base portion 50 to the maximum thickness of the protrusion 52 can be at least about 1:25, at least about 1:10, at least about 1:5, at least about 1:2 and/or not more than about 50:1, not more than about 25:1, not more than about 10:1, not more than about 5:1. The ratio (L₁:T₂) of the maximum distance that protrusion 52 extends outwardly from the base portion 50 to the maximum thickness of protrusion 52 can be in the range of from about 1:25 to about 50:1, about 1:25 to about 25:1, about 1:25 to about 10:1, about 1:25 to about 5:1, about 1:10 to about 50:1, about 1:10 to about 25:1, about 1:10 to about 10:1, about 1:10 to about 5:1, about 1:5 to about 50:1, about 1:5 to about 25:1, about 1:5 to about 10:1, about 1:5 to about 5:1, about 1:2 to about 50:1, about 1:2 to about 25:1, about 1:2 to about 10:1, about 1:2 to about 5:1. Although the above ranges may be include in embodiments of the present invention, certain specific embodiments may provide for the ratio (L₁:T₂) of the maximum distance that protrusion 52 extends outwardly from the base portion 50 to the maximum thickness of protrusion 52 can be in the range of from about 1:10 to about 10:1, about 1:2 to about 5:1, about 1:1 to about 3:1, about 1.25:1 to about 2:1.

The ratio (L₁:T₁) of the maximum distance that the protrusion 52 extends outwardly from base portion 50 to the maximum thickness of the base portion 50 can be at least about 1000:1, at least about 100:1, at least about 50:1, at least about 20:1, and/or not more than 1:80, not more than about 1:60, not more than about 1:40, not more than about 1:20, or in the range of from about 1000:1 to about 1:80, about 1000:1 to about 1:60, about 1000:1 to about 1:40, about 1000:1 to about 1:20, from about 100:1 to about 1:80, about 100:1 to about 1:60, about 100:1 to about 1:40, about 100:1 to about 1:20, from about 50:1 to about 1:80, about 50:1 to about 1:60, about 50:1 to about 1:40, about 50:1 to about 1:20, from about 20:1 to about 1:80, about 20:1 to about 1:60, about 20:1 to about 1:40, about 20:1 to about 1:20. Although the above ranges may be include in embodiments of the present invention, certain preferred embodiments may provide for the ratio (L₁:T₁) be in the range of from about 20:1 to about 1:10, about 15:1 to about 1:5, or about 10:1 to about 1:1.

Given the various types and sizes of projections 52 described above, the cross-section profile of the end-caps 16, in some embodiments, will be generally consistent along an entire length of the end-caps 16. For example, for the projections 52 comprised of a tongue extending down an entire length of the end-cap 16, as illustrated in FIGS. 2, 5, and 6, the end-cap 16 will have a generally consistent cross-sectional profile along its entire length. However, for the projection 52 comprised of a tenon extending down only a portion of the length of the end-cap 16, as illustrated in FIG. 7, or for the projection 52 comprised of a one or more bosses extending from the base 50 of the end-cap 16, as illustrated in FIG. 8, the end-cap 16 may have a different cross-sectional profile along different portions of its length. As will be described in more detail below, it may be preferable to have an end-cap 16 with a generally consistent cross-sectional profile along its entire length, such as illustrated in FIGS. 2, 5, and 6. Specifically, end-caps 16 with consistent cross-section profiles may be manufactured more efficiently and less expensively with profile extrusion molding processes.

To form the article 10, the substrate 12 must initially be dimensioned. Embodiments of the present invention provide for such dimensioning via the dimensioning stage 30, which may include one or more milling, machining, and/or cutting components for forming the substrate 12 from a stock of substrate material. For example, in some embodiments, the substrate 12 may be formed from a larger piece of stock substrate material. As such, during dimensioning of the substrate 12, the substrate 12 may be cut from larger pieces of stock material into a specified size. For example, with reference to FIG. 4, the substrate may be cut into a rectangular-shaped substrate 12 (e.g., having the two faces 40, 42, two elongated side edges 44, and two end edges 46). As such, the final coated article 10 formed from such a rectangular-shaped substrate 12 may be used as a component (e.g., a table top) for a piece of furniture (e.g., a table). Nevertheless, the substrate 12 may be formed into any desired size and/or shape by dimensioning the substrate to a desired profile, width, and/or length.

The substrate 12 used may be rigid or substantially rigid and can have any suitable dimensions. According to one embodiment, the substrate 12 to be coated with coating material 14 for use in one or more extrusion-coated articles 10 may be dimensioned to include a length, or largest dimension, of at least about 0.30 meter, at least about 0.61 meter, at least about 1.22 meter, at least about 2.44 meter, at least about 3.66 meter and/or not more than about 7.62 meter, not more than about 6.10 meter, or not more than about 4.57 meter. In the same or another embodiment, the substrate 12 can have a length in the range of from about 0.30 meter to about 7.62 meter, about 1.22 meter to about 6.10 meter, or about 2.44 meter to about 4.57 meter. The substrate 12 can also have a width, or second largest dimension, of at least about 25.4 mm, at least about 50.8 mm, or at least about 101.6 mm and/or not more than about 3048 mm, not more than about 2032 mm, or not more than about 1016 mm, or in the range of from about 25.4 to about 3048 mm, about 50.8 to about 2032 mm, or about 101.6 to about 1016 mm. The thickness, or shortest dimension, of the substrate 12 can be at least about 6.35 mm, at least about 12.7 mm, at least about 19.05 mm and/or not more than about 203.2, not more than about 101.6 mm, or not more than about 50.8 mm, or in the range of from about 6.35 to about 203.2 mm, about 12.7 to about 101.6 mm, or about 19.05 to about 50.8 mm.

As illustrated in the drawings, and particularly in FIG. 4, the substrates 12 may include the recesses 20 formed into the ends 18 of the substrates 12. Such recesses 20 may be formed into the substrates 12 at the dimensioning stage 30. However, it should be understood that in some examples, the substrate 12 may be formed without recesses 20 on its ends 18. Nevertheless, the substrate 12 may be dimensioned to include a recess 20 within each of its ends 18. The type and/or shape of the recesses 20 may vary depending on requirements of the article 10. For example, in some embodiments, such as illustrated in FIGS. 2 and 4, each recess 20 will comprise a linear groove extending down an entire length of the end 18 of the substrate 12. In other embodiments, such as illustrated in FIG. 7, the recess 20 will include a groove or a mortise that extends down a portion of the length of the end 18. In still other embodiments, such as illustrated in FIG. 8, the recess 20 will include one or more holes formed through a portion of the end 18. In other embodiments, the recesses 20 will be formed as other types of shapes and sizes through at least portions of each of the ends 18 of the substrates 12.

Given the recesses 20 formed in the ends 18 of the substrate 12, as described above, each of the ends 18 of the substrate 12 will present cross-section profiles. In some embodiments, the cross-section profiles of the ends 18 will be generally consistent along an entire length of the ends 18. For example, for the recesses 20 comprised of a groove, extending down an entire length of the end 18, such as illustrated in FIGS. 2 and 4, the end 18 will have a generally consistent cross-sectional profile along its entire length. However, for the recesses 20 comprised of a groove or mortise extending down only a portion of the length of the end 18, such as illustrated in FIG. 7, or for the recesses 20 comprised of a one or more holes formed through the end 18, the ends 18 may have a different cross-sectional profiles along different portions of their lengths. It may be preferable to have recesses 20 formed through the substrate's ends 18 that will provide for the ends 18 to have a generally consistent cross-sectional profile along their entire lengths. As such, the ends 18 of the substrates 12 can be configured to receive end-caps 16 having consistent cross-section profiles along their lengths (e.g., profile extruded end-caps), with such end-caps 16 capable of being efficiently and inexpensively made via profile extrusion processes, as previously described.

In addition to the recesses 20 being formed in the substrates 12 in various types/shapes, embodiments of the present invention allow for the recesses 20 to be formed in various sizes. For example, with reference to FIG. 4, in embodiments in which the recess 20 is a groove or mortise, the ratio of the depth (dᵣ) of the recess 20 to a thickness (T) of the substrate 12 can be at least about 0.10:1, at least about 0.25:1, at least about 0.50:1 and/or not more than about 3:1, not more than about 2:1, not more than about 1:1, or in the range of from about 0.10:1 to about 3:1, about 0.25:1 to about 2:1, or about 0.5:1 to about 1:1. As used herein, the “depth” of a recess 20 is defined as the distance that the recess extends into the substrate 12 from the end edge 46. Similarly, a “width” (wᵣ) of a groove or a mortise-type recess 20 may extend along the end edge 46 of the substrate 12, such that a ratio of the width (wᵣ) of the recess 20 to the thickness (T) of the substrate 12 can be at least about 0.01:1, at least about 0.10:1, at least about 0.20:1 and/or not more than about 0.75:1, not more than about 0.50:1, not more than about 0.25:1, or the ratio of the width (wᵣ) of the recess 20 to the thickness (T) of the substrate 12 can be in the range of from about 0.010:1 to about 0.75:1, about 0.10:1 to about 0.50:1, about 0.20:1 to about 0.25:1.

Remaining with FIG. 4, in embodiments in which the recess 20 is a groove or mortise, the recess may have a length (lᵣ) that extends along at least a portion of the length (L) of the end edge 46 of the substrate 12. In some embodiments, the recess 20 may extend along a portion of the length (L) of the end edge 46 such that the ratio of the length (lᵣ) of the recess 20 to the length (L) of the end edge 46 can be at least 0.50:1, at least about 0.60:1, at least about 0.70:1, and/or not more than about 1:1, not more than about 0.90:1, not more than about 0.80:1 or the ratio of the length (lᵣ) of the recess 20 to the length (L) of the end edge 46 can be in the range of from about 0.50:1 to about 1:1, about 0.60:1 to about 0.90:1, or about 0.70:1 to about 0.80:1. The recess 20 may extend along at least about 50 percent, at least about 60 percent, at least about 70 percent, at least about 80 percent, or at least about 90 percent of the total length (L) of the end edge 46 of the substrate 12. Also, as previously discussed, in certain embodiments, the recess 20 may extend along the entire length (L) of the end edge 46 of the substrate 12.

In other embodiments, as previously described, the recess 20 may not be a groove or mortise, but rather may be, for example, a hole or a slot. According to such embodiments, the sizes of and/or numbers of holes can vary as required for specific manufacturing requirements.

Upon the substrate 12 being dimensioned at the dimensioning stage 30, the substrate 12 may, optionally, be processed through at least one cleaning stage for removing particles of dirt, dust, or other debris from the surface of the substrate 12 before being coated with the coating material 14. Such a cleaning stage may comprise a high pressure steam cleaning, a high pressure air cleaning, a solvent cleaning, a water bath cleaning, and/or any other cleaning process appropriate for the particular type of substrate 12 used. In one embodiment, the cleaning may include a stain bath for staining at least a portion of the substrate 12 prior to coating.

From the dimensioning stage 30 (or the cleaning stage if applicable), the substrate 12 may be provided to the drying stage 32 to be heated prior to coating. The drying stage 32 may be used to dry the substrate 12 by removing any excess moisture or volatile materials from within the substrate 12. The heating may be performed, for example, by transporting the substrate 12 through a heating oven, or some other form of heat application device so as to facilitate the removal of excess moisture. In some embodiment, the recesses 20 may be formed on the ends 18 of the substrate 12 after the substrate 12 has been dried via the drying stage 32.

After moisture has been sufficiently removed from the substrates 12, via the drying stage 32, the substrates 12 can be transferred to the end-capping stage 34 where the end-caps 16 can be coupled with the substrates 12. Specifically, the substrates 12 should preferably be coupled with end-caps 12 having cross-section profiles that substantially correspond (i.e., substantially match) with the cross-section profiles of the substrate's 12 ends 18. In more detail, the end-caps 16 can be engaged with the ends 18 of the substrates 12 by positioning the substrate-facing side 54 of the base portion 50 of the end-cap 16 adjacent to and/or in contact with the end edge 46 of the substrate 12. In such a configuration, each one of the four side edges 58 of the base portion 50 of the end-cap 16 will be aligned with one of the top face 40, bottom face 42, or the two side edges 44 of the substrate 12. In embodiments in which the substrate 12 includes the recess 20 and the end-cap 16 includes the projection 52, at least a portion of the projection 52 of the end-caps 16 will be received within at least a portion of the recesses 20 of the substrate 12. In certain embodiments, glue or other adhesives may be applied between the end-cap 16 and the end edge 46 of the substrate 12 to further facilitate the coupling of the end-cap 16 with the substrate 12. In other embodiments, the projection 52 of the end-cap 16 may be formed slightly larger than the recess 20 of the substrate 12, such that once the end-cap 16 has been engaged with the end 18 substrate 12, the end-cap 16 remains secured in place via an interference fit. For example, in some embodiments, the projection 12 and recess 20 will form a tongue and groove engagement, a boss and hole engagement, and/or a mortise and tenon engagement.

As mentioned, in certain embodiments, the substrates 12 will not include recesses 20 and/or the end-caps 16 will not include protrusions 52. In such embodiments, the end-caps 16 may be secured to the end edges 18 of the substrates 12 via glue or other adhesives. Nevertheless, it may be preferred for the substrates 12 to include recesses 20 and/or for the end-caps 16 to include protrusions 52, so as to provide for an increased surface area for coupling the end-caps 16 with the substrates 12. Such increased coupling surface areas promote the strength of the coupling without requiring significant amounts of adhesives or glue.

In some embodiments, once the end-caps 16 have been secured to the ends 18 of the substrate 12, the substrate 12 (and attached end-caps 16) can optionally pass through a staging area before being introduced into the coating stage 36 via a feed system, which may be configured to properly align the one or more substrates 12 (and attached end-caps 16) being coated in preparation for insertion into the coating stage 36. In certain embodiments, the coating stage 36 may include coating components and processes similar to the extrusion coating components and processes described in U.S. Pat. Nos. 6,660,086 and 7,374,795, which are herein incorporated by reference in their entireties. Such coating components may, for instance, include one or more dies that are configured to extrusion coat coating material 14 onto the substrates 12 (and attached end-caps 16) that are passed through the dies. In other embodiments, the substrate 12 (and attached end-caps 16) may be coated by other means, such as by spraying, brushing, dipping, submerging, or the like.

Nevertheless, the feed system can comprise a plurality of rollers, positioned above and below the substrate 12, which are configured to engage and/or push the substrate 12 or substrates 12 into the dies of the coating stage 36, such that the dies can apply the coating material 14 to the substrates 12 (and attached end-caps 16). The feed system may be configured to supply one or more substrates 12 into dies in a substantially continuous manner, such that, for example, the individual substrates 12 are fed to the dies in a butt-to-butt manner, or in an end-cap 16 to end-cap manner 16, such that contact is maintained between the end-cap 16 of a first substrate 12 and the end-cap 16 of a second substrate 12 fed behind the first substrate 12. According to another embodiment, two substrates 12 may be fed into a die spaced apart from one another, with the space between the substrates being maintained throughout the coating stage 36 simply by appropriate operations of the feed system. According to still another embodiment, as will be discussed in more detail below, two substrates 12 may be fed into a die spaced apart from one another, with the space between the substrates 12 maintained during the coating process via a spacing element positioned between the substrates 12. In some embodiments, as will also be described in more detail below, a double-sided end-cap may be configured to be used as such a spacing element.

As the substrate 12 (and attached end-caps 16) is introduced into the die of the coating stage 36, at least a portion of the surface of the substrate 12 can be coated with the coating material 14 introduced into the die from a coating source. The coating source can be any suitable system or apparatus for providing the coating material 14, and, in one embodiment, may be an extruder. The temperature in the die during the coating process can be any temperature sufficient to maintain the incoming coating material 14 in a liquid or substantially liquid state. In one embodiment, the temperature in the die during coating can be at least about 50° C., at least about 100° C., at least about 200° C. and/or not more than about 500° C., not more than about 400° C., not more than about 300° C., or in the range of from about 50 to about 500° C., about 50 to about 400° C., about 50 to about 300° C., about 100 to about 500° C., about 100 to about 400° C., about 100 to about 300° C., about 200 to about 500° C., about 200 to about 400° C., about 200 to about 300° C. The pressure in the die during the coating step can be at least about 0.172 Mpa at least about 0.345 Mpa, at least about 0.689 Mpa and/or not more than about 34.474 Mpa, not more than about 24.132 Mpa, not more than about 13.790 Mpa, not more than about 10.342 Mpa, not more than 6.895 Mpa, or in the range of from about 0.0172 to about 34.474 Mpa, about 0.172 to about 24.132 Mpa, about 0.172 to about 13.790 Mpa, about 0.172 to about 10.342 Mpa, or about 0.172 to about 6.895 Mpa, about 0.345 to about 34.474 Mpa, about 0.345 to about 24.132 Mpa, about 0.345 to about 13.790 Mpa, about 0.345 to about 10.342, or about 0.345 to about 6.895 Mpa, about 0.689 to about 34.474 Mpa, about 0.689 to about 24.132 Mpa, about 0.689 to about 13.790 Mpa, about 0.689 to about 10.342, or about 0.689 to about 6.895 Mpa.

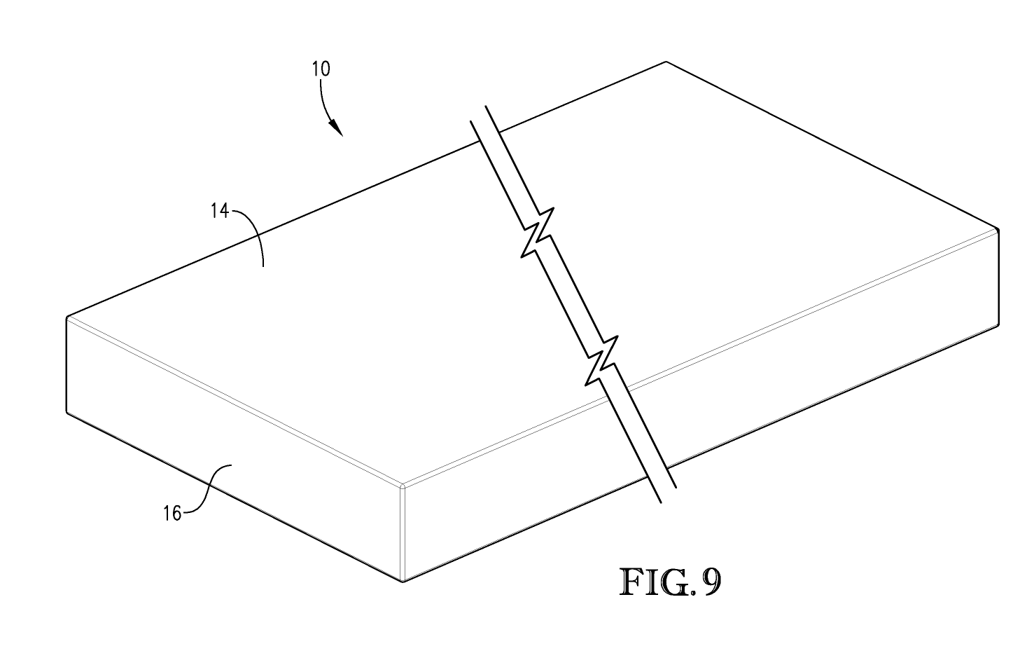

Regardless of the specific parameters of the die, in general, the exterior surface of the substrate 12 will be entirely coated with coating material 14 so as to create the coated article 10, such as illustrated in FIGS. 1 and 9. In more detail, the coating material 14 should completely cover the substrate's 12 top and bottom faces 40, 42 and its elongated side edges 44. Additionally, the coating material 14 will be applied to at least a portion of the exterior surface of the end-caps 16, which are attached to the ends 18 of the substrates 12. Specifically, the coating material 14 should at least be applied to a portion of the four side edges 58 of the base portion 50 of the end-caps 16, with such side edges 58 being positioned directly adjacent to the substrate 12. As such, the coating material 14, which is molten and heated (e.g., between about 200-300° C.), will fuse with the end-caps 16, thus, sealing the substrate 12 and the end-caps 16 within the coating material 14. In particular, the coating material 14 will entirely coat the top and bottom faces 40, 42 and the elongated side edges 44, while the end-caps 16 will cover the substrate's 16 end edges 46. Furthermore, the coating material 14 will fuse together with the four side edges 58 of the end-caps 16, such that the substrate 12 is entirely and continuously sealed within the coating material 14 and/or the end-caps 16. Thus, the substrate 12 is completely sealed from external contaminations, such as water.

The average thickness of coating material 14 coated onto the substrate 12 can be at least about 0.0254 mm, at least about 0.127 mm, at least about 0.254 mm and/or not more than about 0.635 mm, not more than about 0.508 mm, not more than about 0.381 mm, or in the range of from about 0.0254 to about 0.635 mm, about 0.0254 to about 0.508, about 0.0254 to about 0.381 mm, about 0.127 to about 0.635 mm, about 0.127 to about 0.508, about 0.635 to about 0.381 mm, about 0.254 to about 0.635 mm, about 0.254 mm to about 0.508 mm, about 0.254 to about 0.381 mm, depending on the specific configuration of the article 10. Upon coating the substrate 12 with the coating material 14, the end-caps 16 should be securely coupled with the substrate 12. In certain embodiments, the end-caps 16 should require a peel force of at least 250 grams, at least 500 grams, at least 1000 grams, at least 1,500, or at least 2,000 grams to separate the end-caps 16 from the substrate 12.

In some optional embodiments, the extrusion-coated article 10 exiting the coating stage 36 may be routed to a cooling or quench stage, wherein the extrusion-coated article 10 can be cooled via contact with a cooling fluid. In one embodiment, the cooling performed in cooling or quench stage may be sufficient to reduce the surface temperature of the article 10 by at least about 5° C., at least about 10° C., at least about 15° C., at least about 20° C., at least about 25° C., or at least about 30° C. Examples of suitable cooling fluids can include air, an inert gas, and/or water, and a quench stage may or may not have a pressure greater than atmospheric.

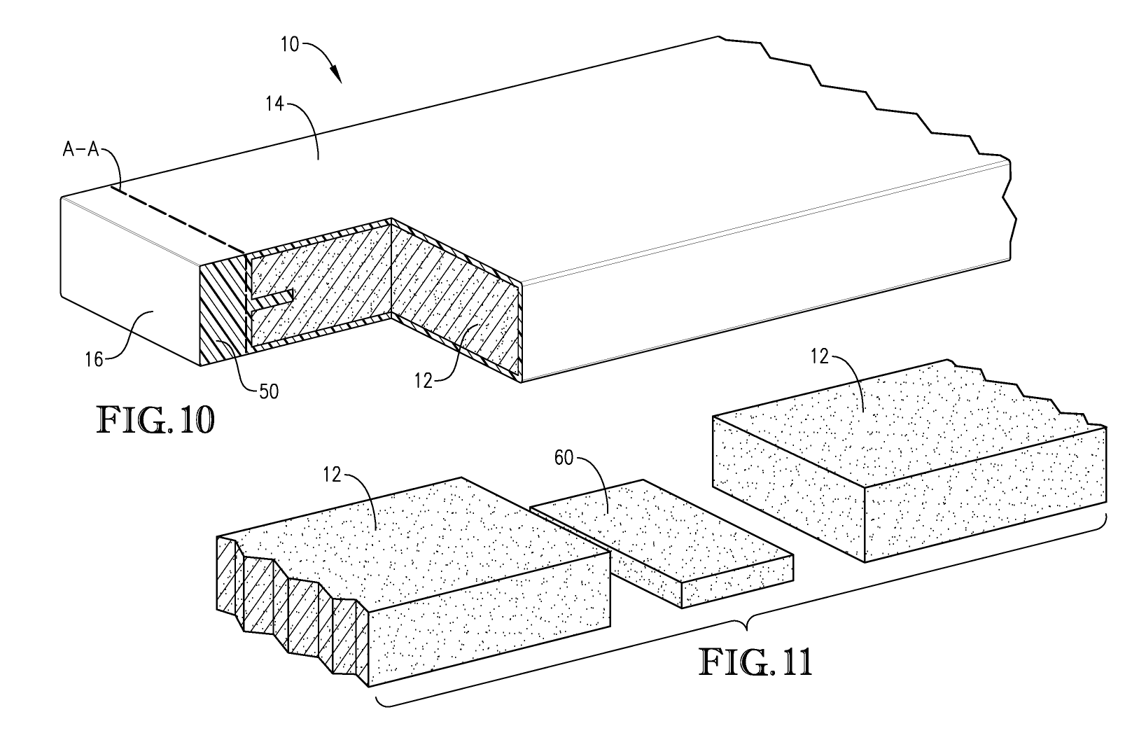

After the coating material 14 has been applied to the substrate 12 via the coating stage and after the article 10 has cooled (if necessary), a portion of the end-caps 12 and/or the coating material 14 can be trimmed from the article 10 at the trimming stage 38. In certain embodiments, as illustrated in FIG. 10, the base portion 50 of the end-caps 16 may be oversized (i.e., having an oversized thickness) such that a portion of the end-cap's 16 thickness may be trimmed away. Such trimming may be performed with various tools and/or machinery, such as with a reciprocating saw, a band saw, a laser cutter, or the like. For example, as shown in FIG. 10, some of the base portion 50 of the end-cap 16 may be trimmed away along the line A-A. Such trimming may provide for the article 10, and in particular the end-cap 16, to have a smooth, burr free appearance without exposing the end edge 46 of the substrate 12. In such embodiments, the portion of the end-cap that was trimmed away may be recycled as material that can be used to form additional end-caps 16 or coating material 14. In further embodiments, the end-caps 16 may be drilled or tapped so as be operable to connect other articles thereto, without exposing the substrate 12. In still further embodiments, decorative features may be formed on the end-caps 16, such as by machining, laser etching, or the like; all without exposing the substrate 12.

As described above, the substrates 12 may be fed through one or more of the stages in an assembly line-type process. Specifically, with respect to the coating stage 36, the substrates 12 can generally be positioned end to end, such that end-caps 16 of adjacent substrates 12 are adjacent to each other and/or contact each other. As such, the line of substrates 12 (including their end-caps 16) can be processed through the die(s) of the coating stage 36 in a continuous fashion. Once the substrates 12 and the associated end-caps 16 have been coated with coating material 14 so as to form the coated articles 10, individual coated articles 10 can be separated from adjacent coated articles 10 by simply separating the articles 10. In some embodiments, the individual coated articles 10 may be partially secured or stuck together via coating material 14, such that the individual coated articles 10 may need to be separated by trimming the coating material 14 connecting the adjacent articles 10 and/or trimming the end-caps 16 separating adjacent articles 10.

The process described above utilized individual end-caps 16 to be engaged with and to cover both ends 18 of the each of the substrates 12. However, embodiments of the present invention alternatively provide for the coating material 14 itself to function as end-caps 16, so as to cover the end edges 46 of the substrates 12. In such embodiments, the dimensioning and drying stages 30, 32 would be generally the same as previously described, except that the substrate 12 would not require a recess 20 to be formed in either of its ends 18. As such, the substrates 12 can be placed in a line through the die of the coating stage 36. It should be understood that the substrates 12 cannot be positioned directly end to end with the end edges 46 of adjacent substrates 12 touching each other because such a configuration would not allow for the end edges 46 to become coated with coating material 14. Additionally, however, the coating stage 36 may not operate properly if substrates 12 are placed through the dies in separated fashion with significant spaces or gaps between adjacent substrates 12 because such gaps may create pressure drops that interfere with application of the coating material 14. As such, embodiments of the present invention may provide for the substrates 12 to only be separate by small gaps as the substrates 12 are processed through the coating stage 36. In such embodiments, the small gaps will not interfere with the pressure requirement of the coating process, but will, instead, allow for the coating material 14 to coat the entire surface of the substrates 12. In some alternative embodiments, such as illustrated in FIG. 11, spacing elements 60 may be positioned between each of the substrates 12 so as to fill a significant portion of the volume of the gaps. As such, the spacing elements 60 allow the substrates to be separated, while reducing pressure drops that can arise from gaps present between the substrates 12.

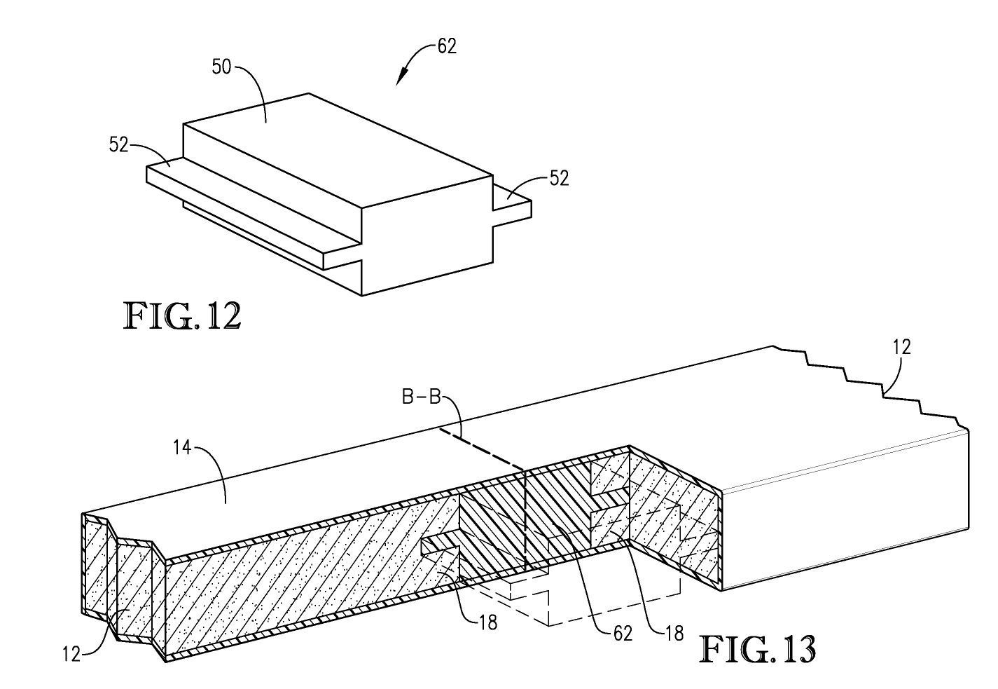

Further embodiments of the present invention provide for the substrates 12 to be separated by a double-sided end-cap 62, such as illustrated in FIG. 12. In such embodiments, the double-sided end-cap 62 may include projections 52 that extend from both sides of the base portion 50. As such, the double-sided end-cap 62 may be secured to an end 18 of a first substrate 12, via a recess 20 within the end 18 of the first substrate 12, and also secured to an end 18 of a second substrate 12, via a recess 20 within the end 18 of the second substrate 12. In such a configuration, and as illustrated in FIG. 13, the connected substrates 12 and the connecting double-sided end-cap 62 can be fed through the coating stage 36, where the substrates 12 and the double-sided end-cap 62 can be coated with coating material 14. As with previously-described embodiments, the coating material 14 will coat the substrates 12 and will also fuse to the double-sided end-cap 62. After all the exposed surfaces of the substrates 12 and the double-sided end-cap 62 have been coated with coating material 14, the substrates 12 can be separated at the trimming station 38 by cutting/trimming the double-sided end-cap, such as along the line B-B in FIG. 13. As such, the resulting individual coated articles 10 will be generally the same in appearance as the individual coated articles 10 discussed above in previous embodiments.

The process described above details how to prepare an article 10 comprising a substrate 12 that is entirely sealed from external elements by a coating material 14 and end-caps 16. Such a process may be performed in an assembly-line fashion, via a conveyor operable to process a plurality of substrates 12 in a given timeframe through each of the stages. The rate at which the number of substrates 12 can be processed is dependent upon the number of coats of coating material 14 that is to be applied to the substrates 12, whether any cooling is necessary between coating stages 36 and the trimming stages 36, and whether any type of finishing operations are performed.

As discussed previously, extrusion-coated articles 10 of the present invention have a wide variety of applications including, for example, as furniture or cabinetry items and/or in several indoor and outdoor construction and building end-uses. In one embodiment, one or more extrusion-coated article(s) 10 described herein may be used in cabinetry applications as doors, side walls, drawers, cabinet boxes, and other similar components, and may be used in furniture applications as shelves, tables, desks, drawers, cabinets, chairs, and the like. Specific construction uses can include, but are not limited to, wall board, floor board, trim, door jambs or casing, window jambs or casing, crown molding, chair railing, frames, mantels, accent boxes, and the like.

The various aspects of the present invention can be further illustrated and described by the following Example. It should be understood, however, that the Example is included merely for purposes of illustration and is not intended to limit the scope of the invention, unless otherwise specifically indicated.

### Example

### Pull-Off Strength Measurements of Extrusion-Coated Substrates

Samples of M2 grade particle board substrate were coated with 1,4-cyclohexanedimethanol modified polyethylene terephthalate (PETG) and ExxonMobil Chemical's LL 6201.19 linear low-density polyethylene (LLDPE) through the extrusion coating process described in U.S. Pat. Nos. 6,660,086 and 7,374,795. An extrusion temperature (i.e., the polymer melt temperature in the die during extrusion) of 500° C. was used for each coating. The substrates were processed through the die at a rate of 4.6 meters per minute. After coating each of the substrate samples, the adhesion of the coating to the substrate was evaluated using a PosiTest AT-A pull-off adhesion tester (20 mm diameter dolly). The pull-off strength was measured using ASTM D4541-09. The average results are summarized in Table 1, below.

TABLE 1
Average Results for Pull-Off Strength

| | | Pull-Off | Coating |
|---|---|---|---|
| | Coating | Strength | Material |
| Substrate | Material | (MPa) | Thickness, mm |
| M2 Particle | PETG | 2.37 | 0.295 |
| Board | | | |
| M2 Particle | LLDPE | 1.52 | 0.302 |
| Board | | | |

As illustrated by Table 1, the particle board substrate with the PETG coating material had an average pull-off strength of 2.37 MPa. Alternatively the particle board substrate with the LLDPE coating material had an average pull-off strength of 1.52 MPa. Thus, in the present example, the PETG coating material showed enhanced adhesion properties over the LLDPE coating material.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from, but outside the literal scope of the invention as set forth in the following claims.

We claim:

1. An extrusion-coated article comprising:
a substrate;
a coating material extrusion coated onto at least a portion of said substrate; and
at least one profile extruded end-cap coupled with an end of said substrate, with a cross-section of said end-cap comprising an end-cap profile,
wherein the end of said substrate comprises a recess extending inwardly from an outer surface of the end of said substrate, such that a cross-section of the end comprises a substrate end profile,
wherein the end-cap profile substantially corresponds with the substrate end profile, such that at least a portion of said end-cap is operable to be received within the recess for coupling said end-cap with the end of said substrate.

2. The article of claim 1, wherein the recess extends along an entire length of the end of said substrate, such that the substrate end profile is generally consistent along the entire length of the end of said substrate.

3. The article of claim 1, wherein the end-cap profile is consistent along an entire length of said end-cap.

4. The article of claim 1, wherein said end-cap is profile extruded from the same material of which the coating material is comprised.

5. The article of claim 1, wherein said substrate comprises natural wood, medium-density fiberboard, particle board, oriented strand board, plastic, cellularized PVC, foam, metal, fiberglass-reinforced thermoset or thermoplastic polymers, or combinations thereof.

6. The article of claim 1, wherein the coating material comprises one or more resins selected from the group consisting of polyesters, copolyesters, polycarbonates, polymethyl methacrylate (PMMA), impact-modified PMMA, poly(acrylonitrile-styrene-acrylate) (ASA), poly(acrylonitrile-butadiene-styrene) (ABS), poly(styrene-acrylonitrile) (SAN), cellulose esters and mixtures thereof.

7. The article of claim 1, wherein the coating material is at least partially fused with said end-cap so as to form a seal around the end of said substrate.

8. A method for forming an extrusion-coated article, said method comprising the steps of:
(a) providing a substrate;
(b) forming a recess in an end of the substrate;
(c) profile extruding an end-cap;
(d) coupling said end-cap with the end of said substrate; and
(e) extrusion-coating said substrate and said end-cap so as to coat at least a portion of said substrate and said end-cap with a coating material,
wherein said end-cap includes a cross-section comprising an end-cap profile, and wherein the end of said substrate comprises a recess extending inwardly from an outer surface of the end, such that a cross-section of the end comprises a substrate end profile,
wherein the end-cap profile substantially corresponds with the substrate end profile, such that at least a portion of said end-cap is operable to be received within the recess for coupling said end-cap with the end of said substrate.

9. The method of claim 8, wherein the recess is formed consistently along an entire length of the end of said substrate, such that the substrate end profile is generally uniform along the entire length of the end of said substrate.

10. The method of claim 8, wherein said end-cap is profile extruded such that the end-cap profile is uniform along an entire length of said end-cap.

11. The method of claim 8, wherein the end-cap is profile extruded from the same material of which the coating material is comprised.

12. The method of claim 8, wherein during said extrusion-coating of step (e), said coating material is at least partially fused with said end-cap so as to form a seal around the end of said substrate.

13. The method of claim 12, wherein said coating material has a glass transition temperature in the range of from about 60° C. to about 80° C.

14. The method of claim 8, wherein said substrate comprises natural wood, medium-density fiberboard, particle board, oriented strand board, plastic, cellularized PVC, foam, metal, fiberglass-reinforced thermoset or thermoplastic polymers, or combinations thereof.

15. The method of claim 8, wherein said coating material comprises one or more resins selected from the group consisting of polyesters, copolyesters, polycarbonates, polymethyl methacrylate (PMMA), impact-modified PMMA, poly(acrylonitrile-styrene-acrylate) (ASA), poly(acrylonitrile-butadiene-styrene) (ABS), poly(styrene-acrylonitrile) (SAN), cellulose esters and mixtures thereof.

16. A method for forming an extrusion-coated article, said method comprising the steps of:
(a) providing a substrate and an end-cap;
(b) coupling said end-cap with an end of said substrate; and
(c) passing the coupled substrate and end-cap through an extrusion-coater so as to coat at least a portion of each of said substrate and said end-cap with a coating material,
wherein during said passing of step (c), the coating material at least partially fuses with said end-cap, so as to form a seal around the end of said substrate; and
(d) machining an end portion of said end-cap, such that said end-cap presents a smooth outer surface.

17. The method of claim 16, wherein the machining of step (d) comprises trimming away a portion of the end portion of said end-cap.

18. The method of claim 17, further including the step of: recycling the end portion of said end-cap that is trimmed away during the trimming step.

19. The method of claim 16, further including the step of: forming a decorative feature on the outer surface of the machined end-cap.

20. The method of claim 16, wherein said coating material has a glass transition temperature in the range of from about 60° C. to about 80° C.
